(19) United States
(12) Patent Application Publication
(10) Pub. No.: US 2005/0179146 A1
(43) Pub. Date: Aug. 18, 2005

(54) Fuel pressure regulating apparatus for carburetors

(75) Inventors: Yoshiharu Iwasa, Iwate-Ken (JP); Mamoru Toda, Iwate-Ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Zama Japan Co., Ltd., Iwate-Ken (JP)

(21) Appl. No.: 11/054,433

(22) Filed: Feb. 10, 2005

(30) Foreign Application Priority Data
Feb. 16, 2004 (JP) 2004-037622

(51) Int. Cl. F02M 69/02

(52) U.S. Cl. 261/35; 261/69.1; 261/DIG. 68

(57) ABSTRACT

The apparatus prevents fuel vapor from being discharged to an intake passage from a fuel metering chamber of a carburetor and maintains a substantially constant fuel pressure in the fuel metering chamber so as to stabilize the amount of the fuel discharged to the intake passage. The pump has a drive force produced by a pulsation pressure generated in a crank chamber of an engine or an intake tube. A discharge chamber of a fuel pump and a fuel tank are connected by a relief passage, and the relief passage is provided with a pressure regulating valve discharging a pressure equal to or greater than a set pressure in the discharge chamber to the fuel tank. Fuel vapor is prevented from being generated in an inner portion of a fuel metering chamber and the amount of fuel discharged to an intake passage is stabilized, by discharging a part of the fuel at a time when a pump discharge fuel pressure is high to the fuel tank together with the fuel vapor generated in the fuel pump, and only feeding the fuel at the set pressure to the fuel metering chamber. Further, because the fuel having a comparatively low temperature is circulated in the fuel pump and within the fuel tank by discharging excess fuel to the fuel tank, the carburetor is cooled, and the generation of fuel vapor is inhibited.

### BACKGROUND OF THE INVENTION

This application claims the benefit of Japanese Patent Application No. 2004-037622, filed Feb. 16, 2004, which is incorporated herein by reference.

1. Filed of the Invention

The present invention relates to an apparatus for maintaining a substantially constant fuel pressure in a fuel metering chamber of a carburetor mainly for an internal combustion engine. More particularly, the present invention relates to a fuel pressure regulating apparatus which stably maintains a desired fuel pressure without feeding fuel vapor generated in a fuel pump to the fuel metering chamber and without generating fuel vapor within the fuel metering chamber.

2. Description of Related Art

A diaphragm-type carburetor is employed, as are most carburetors, to supply fuel to an internal combustion engine, particularly, to such an engine having a limited displacement. The fuel pump feeding fuel to the fuel metering chamber generally employs a pulsation-type, diaphragm fuel pump which draws fuel from the fuel tank so as to pressurize and discharge fuel towards the fuel metering chamber by the reciprocating motion of a pump diaphragm resulting from a pulsation pressure generated in a crank chamber or an intake tube in accordance with engine operation.

The fuel pump mentioned above is provided with a first pulse chamber and a second pulse chamber, which are divided by a pump diaphragm; an inlet check valve; an outlet check valve; and a discharge chamber. Fuel in a fuel tank is drawn into the first pulse chamber from the inlet check valve through a suction passage, and is pressurized so as to be fed to a fuel metering chamber of the carburetor from the outlet check valve through the discharge chamber, a feeding passage, and an inlet valve. The discharge chamber is provided just after the outlet check valve and may have a significantly greater volumetric capacity for the purposes of providing sufficient installation space for a strainer and of leveling the pressure of the fuel discharged from the pump. The fuel passing through the outlet check valve enters into the discharge chamber and flows to the fuel metering chamber through the feeding passage.

When the pulsation pressure generated in the crank chamber or the intake tube and introduced into the second pulse chamber becomes negative, the volumetric capacity of the first pulse chamber is increased so as to draw fuel into it. Nevertheless, in this case, the fuel pressure becomes negative as the fuel passes through the check valve. When the pulsation pressure becomes positive, the volumetric capacity of the first pulse chamber is reduced so as to pressurize the drawn fuel. The outlet check valve then opens and discharges the drawn fuel to the discharge chamber. When the pulsation pressure in the crank chamber is introduced to the second pulse chamber, the fuel discharge pressure increases in response to the engine shift to the higher output drive condition, and when the pulsation pressure of the intake tube is introduced to the second pulse chamber, the fuel discharge pressure increases in response to the engine shift to the no-load running condition. In other words, a condition occurs in which the fuel pressure change is greater within the first pulse chamber in the region of the running engine, in which the fuel discharge pressure increases, and in which the entry of the higher pressure fuel into the discharge chamber lowers the fuel pressure, so as to more readily generate fuel vapor. In particular, when the temperature of the fuel pump and its surrounding components increase due to engine heat or the like, fuel vapor tends to be generated in the inner portion of the first pulse chamber. When such fuel vapor is generated, fuel vapor is discharged together with the fuel to the discharge chamber.

When the generated fuel vapor enters into the fuel metering chamber through the feeding passage and is discharged to the intake passage from the main nozzle or the like, the rotational speed of the engine may decline or the engine may stop due to a lean air-fuel mixture. As a countermeasure to this, Japanese Unexamined Patent Publication No. 9-158806 proposes that the greater negative pressure within the second pulse chamber in the no-load to the low load running conditions is inhibited by connecting the portion of the carburetor intake passage upstream side of the throttle valve to the second pulse chamber of the fuel pump, thereby preventing the fuel discharge pressure from increasing to an undesirable level, whereby the pulsation pressure of the intake tube is set as the driving force of the fuel pump. Further, Japanese Unexamined Patent Publication No. 2000-297702 proposes that fuel vapor stored in an upper portion of the fuel metering chamber of the carburetor is discharged by configuring a purge pump using the pulsation pressure of the intake tube as its driving force, whereby the pulsation pressure of the intake tube is set as the driving force of the fuel pump in the same manner.

Nevertheless, each of the proposals mentioned above corresponds to the countermeasure whereby the pulsation pressure of the intake pipe is set as the driving force of the fuel pump, and in particular, the former may not be applied to when the pulsation pressure of the crank chamber is set as the driving force of the fuel pump. On the other hand, although the latter may be applied when the pulsation pressure of the crank chamber is set as the driving force of the fuel pump, because the generated fuel vapor is discharged from the upper portion of the fuel metering chamber, the risk that fuel vapor is discharged to the intake passage from the main nozzle so as to make the air-fuel mixture excessively lean may not be completely eliminated and the fuel pressure within the fuel metering chamber may become unstable.

### SUMMARY OF THE INVENTION

The present invention reduces the amount of or prevents fuel vapor from being discharged to the intake passage in the manner permitted by the known countermeasures mentioned above. In particular, the discharge of fuel vapor to the intake passage is reduced or eliminated, when the fuel pump has a driving force resulting from the pulsation pressure of either the crank chamber or the intake tube. An object of the present invention is to provide a fuel pressure regulating apparatus for a carburetor which may maintain a fuel pressure within a fuel metering chamber so as to provide a stable supply of fuel to an engine without feeding fuel vapor generated in a fuel pump to the fuel metering chamber, without generating fuel vapor within the fuel metering chamber, and, accordingly, without the risk of discharging fuel vapor to the intake passage.

In accordance with the present invention, a means for achieving the object mentioned above is provided by a structure in which a discharge chamber of a fuel pump, which has a driving force resulting from a pulsation pressure generated in a crank chamber of an engine or an intake tube, and a fuel tank are connected by a relief passage. The relief passage comprises a pressure regulating valve for discharging fuel at a pressure equal to or greater than a set value for the fuel discharge pressure from the discharge chamber to the fuel tank.

When the fuel pressure in the discharge chamber becomes equal to or greater than the set value in the portion of the running engine and the fuel discharge pressure in the fuel pump increases, the pressure regulating valve is opened to discharge a portion of the fuel in the discharge chamber to the fuel tank, and fuel vapor generated in the fuel pump at this time is discharged to the fuel tank together with the fuel. Accordingly, fuel vapor generated in the fuel pump is not fed into the fuel metering chamber of the carburetor.

Further, the fuel pressure may be set within the fuel metering chamber to a minimum pressure by setting the set value of the pressure regulating valve to a reduced value. Accordingly, the fuel pressure in the fuel metering chamber is maintained substantially constant, and the risk that fuel vapor is generated within the fuel metering chamber is reduced or eliminated. Further, because the fuel having a pressure equal to or greater than the set pressure of the pressure regulating valve is discharged as excess fuel to the fuel tank, and because fuel having a comparatively lower temperature is circulated in the fuel pump and within the fuel tank, the carburetor is cooled, and the generation of fuel vapor is inhibited.

In accordance with the present invention, fuel vapor is not discharged to the intake passage so as to cause a reduction in the rotational speed of the engine or stoppage of the engine, and the fuel pressure within the fuel metering chamber is maintained substantially constant so as to provide a stable supply of fuel to the engine, whereby engine efficiency and performance may be improved.

Other objects, features, and advantages will be apparent to those of ordinary skill in the relevant art in view of the following detailed description of preferred embodiment and the accompanying drawings.

### BRIEF DESCRIPTION OF THE DRAWINGS

FIG. 1 is a vertical, cross-sectional view of an embodiment of a carburetor in accordance with the present invention.

### DESCRIPTION OF PREFERRED EMBODIMENTS

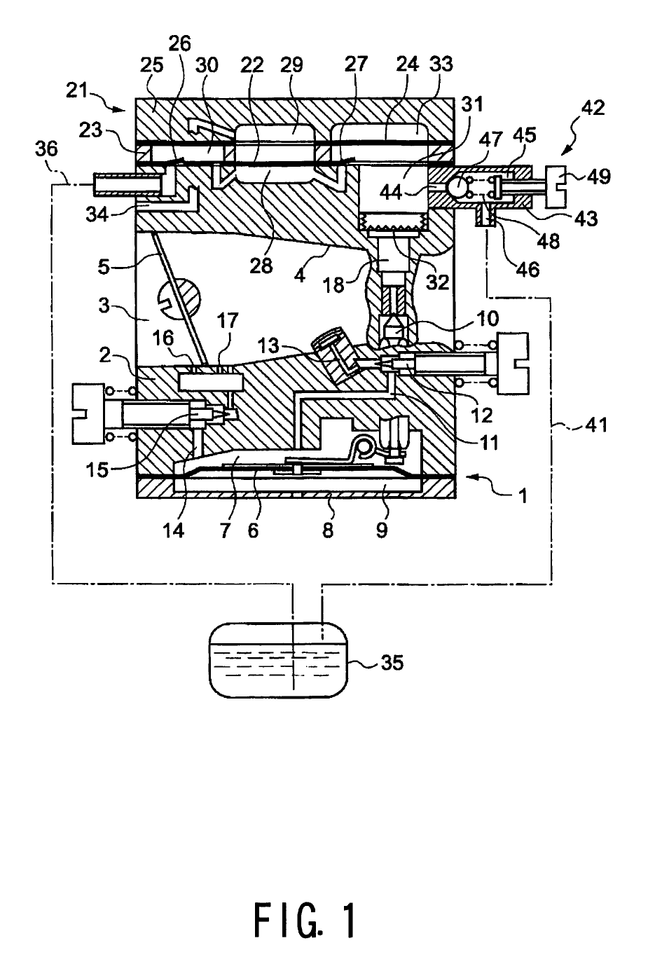

A description is given of the embodiment depicted in FIG. 1, in which the present invention is applied to a structure obtained by assembling a pulsation-type, diaphragm fuel pump in a diaphragm-type carburetor. A main body 2 of a carburetor 1 comprises a horizontal intake passage 3 comprising a venturi tube 4 and a throttle valve 5. Main body 2 further comprises a fuel metering chamber 7 separated from an atmospheric air chamber 9 formed within a lower diaphragm cover 8 by a diaphragm 6, which is placed in a lower surface of the main body 2. Fuel fed from a fuel pump 21 through an inlet valve 10, which valve 10 opens and closes in response to the displacement of diaphragm 6, is fed into fuel metering chamber 7. The fuel passes through a main fuel passage 11 and is regulated in its flow rate by a first fuel regulating, needle valve 12 so as to be discharged to a portion of venturi tube 4 of intake passage 3 from a main nozzle 13. The fuel passes through a low speed fuel passage 14 and is regulated in its flow rate by a second fuel regulating, needle valve 15 so as to be discharged upstream or downstream of throttle valve 5 of intake passage 3 from an idle port 16 and a slow port 17.

A pump diaphragm 22, a spacer 23, a pulsator diaphragm 24, and a pump cover 25 are arranged in sequence and overlap on an upper surface of main body 2, and an inlet check valve 26 and an outlet check valve 27 are formed in pump diaphragm 22. Further, a first pulse chamber 28 is formed in a cavity of main body 2 with respect to pump diaphragm 22, and a second pulse chamber 29 is formed in a center portion of spacer 23 and in a cavity of pump cover 25 with respect to pump diaphragm 22. A suction chamber 30 is formed in one side portion of spacer 23 between pulsator diaphragm 24 and pump diaphragm 22, and a discharge chamber 31 comprising a strainer 32 positioned therein is formed in another side portion of spacer 23 and in main body 2 with respect to pulsator diaphragm 24. Further, an air chamber 33 adjacent discharge chamber 31 with respect to pulsator diaphragm 24 is formed in another cavity in pump cover 25. Accordingly, fuel pump 21 comprises each of the portions described above.

The pulsation pressure generated in the crank chamber of the engine or the intake tube is introduced to second pulse chamber 29 through pulse passage 34. Further, fuel in fuel tank 35 passes through suction passage 36 and is drawn into first pulse chamber 28 via inlet check valve 26 and suction chamber 30, is pressurized so as to enter into discharge chamber 31 from outlet check valve 27, and is fed to fuel metering chamber 7 from feeding passage 18 via inlet valve 10. The configuration of diaphragm-type carburetor 1 obtained by assembling fuel pump 21 as described above and the operation of fuel pump 21 and carburetor 1 are substantially the same as known fuel pumps and carburetors.

Discharge chamber 31 and fuel tank 35 are connected by a relief passage 41, and relief passage 41 comprises a pressure regulating valve 42. Pressure regulating valve 42 may comprise a valve main body 43 having an inlet 44, a valve chamber 45, and an outlet 46. Valve 42 further comprises a valve body 47 and a sealing spring 48, which are disposed in valve chamber 45. In addition, an adjusting screw 49 may be received, e.g., screwed, into valve main body 43; and valve 42 is structured, such that valve main body 43 is fixed to main body 2, inlet 44 is open to discharge chamber 31, and outlet 46 is connected to relief passage 41.

Sealing spring 48 urges valve body 47 to close inlet 44, and adjustments to sealing spring 48 may be made unnecessary by previously selecting a spring having a predetermined bias. Nevertheless, in the depicted embodiment, a bias of sealing spring 48 may be adjusted by adjusting screw 49 in such a manner as to apply a desired closing bias to valve body 47 after fixing carburetor 1 on the engine.

When a valve opening force of pressure regulating valve 42 caused by the fuel pressure in discharge chamber 31 becomes greater than a bias of sealing spring 48, pressure regulating valve 42 is opened so as to discharge fuel in discharge chamber 31 to the tank 35 via relief passage 41. When the fuel pressure in discharge chamber is reduced to the set value of pressure regulating valve 42, the valve is closed. When fuel vapor is generated in fuel pump 21, fuel vapor is discharged to fuel tank 35 together with the fuel, whereby the fuel discharged from fuel pump 21 removes the fuel vapor, and the pressure of the fuel vapor is reduced to a fixed pressure so as to be fed to fuel metering chamber 7. Because the fuel having a pressure equal to or greater than the set pressure of pressure regulating valve 42 is discharged as excess fuel to fuel tank 35, and because fuel having a comparatively low temperature is fed constantly to fuel pump 21, the carburetor is cooled so as to further inhibit the generation of the fuel vapor.

Further, because the fuel having the pressure set by pressure regulating valve 42 or the pressure lower than that set pressure in accordance with the operational state of the engine is fed to fuel metering chamber 7, fuel vapor is not generated in the inner portion of fuel metering chamber 7, and the change in the fuel pressure is reduced so as to minimize the deviation of the amount of fuel discharged to intake passage 3. In the present embodiment, the fuel pressure may be maintained within fuel metering chamber 7 at a stable, minimum pressure desired for discharge to intake passage 3 so as to discharge a stable amount of fuel to intake passage 3, by reducing the bias of sealing spring 48 so as to reduce the set value of pressure regulating valve 42.

As mentioned above, the apparatus is particularly effective for stabilizing the amount of fuel discharged to intake passage 3 when fuel metering chamber 7 of the diaphragm-type carburetor has a reduced volumetric capacity, and the fuel is always filled to maintain the fuel pressure of fuel metering chamber 7 at a stable reduced pressure.

Although preferred embodiments of the present invention have been described in detail herein, the scope of the invention is not limited thereto. It will be appreciated by those of ordinary skill in the relevant art that various modifications may be made without departing from the scope of the invention. Accordingly, the embodiments disclosed herein are only exemplary. It is to be understood that the scope of the invention is not to be limited thereby, but is to be determined by the claims which follow.

1. A fuel pressure regulating apparatus of a carburetor comprising a fuel pump, said fuel pump comprising a discharge chamber, wherein said fuel pump has a driving force resulting from a pulsation pressure generated in a crank chamber of an engine or an intake tube, and a fuel tank, which are connected by a relief passage, and said relief passage comprises a pressure regulating valve for discharging fuel at a pressure equal to or greater than a set value of the fuel discharge pressure from said discharge chamber to said fuel tank.

2. The apparatus of claim 1, wherein said pressure regulating valve feeds fuel to a fuel metering chamber when said fuel pressure is less than said set value of the fuel discharge pressure.

3. A carburetor comprising said fuel pressure regulating apparatus of claim 1.

4. The carburetor of claim 3, wherein said carburetor is a diaphragm-type carburetor.

5. An internal combustion engine comprising a carburetor comprising said fuel pressure regulating apparatus of claim 1.

6. A carburetor comprising:
a fuel pump comprising a first pulse chamber and a second pulse chamber, which chambers are divided by a pump diaphragm, an inlet check valve, an outlet check valve, and a discharge chamber,
wherein said fuel pump has a driving force resulting from a pulsation pressure generated in a crank chamber of an engine or an intake tube;
whereby fuel in a fuel tank is drawn into said first pulse chamber from said inlet check valve through a suction passage, and is pressurized and fed to a fuel metering chamber from said outlet check valve through said discharge chamber, a feeding passage, and an inlet valve; and
wherein said discharge chamber is disposed after said outlet check valve, comprises a strainer, and levels the pressure of the fuel discharged from said fuel pump, such that the fuel passing through said outlet check valve enters into said discharge chamber and flows to said fuel metering chamber through said feeding passage; and
a relief passage connecting said discharge chamber and said fuel tank and said relief passage comprises a pressure regulating valve for discharging fuel at a pressure equal to or greater than a set value of the fuel discharge pressure from said discharge chamber to said fuel tank.

7. The carburetor of claim 6, wherein said pressure regulating valve comprises a valve main body having an inlet, a valve chamber, and an outlet and wherein said pressure regulating valve further comprises a valve body and a sealing spring, which are disposed in said valve chamber, such that said valve main body is fixed to said main body, said inlet is open to said discharge chamber, and said outlet is in communication with said relief passage.

8. The carburetor as claimed in claim 7, further comprising an adjusting screw for adjusting a bias of said sealing spring.

9. An internal combustion engine comprising the carburetor of claim 6.
